(19) United States
(12) Patent Application Publication
(10) Pub. No.: US 2015/0205890 A1
(43) Pub. Date: Jul. 23, 2015

(54) TOPOGRAPHY SIMULATION APPARATUS, TOPOGRAPHY SIMULATION METHOD AND RECORDING MEDIUM

(71) Applicant: KABUSHIKI KAISHA TOSHIBA, Tokyo (JP)

(72) Inventors: Naoki TAMAOKI, Tokyo (JP); Yoshinori YOKOTA, Tokyo (JP)

(73) Assignee: KABUSHIKI KAISHA TOSHIBA, Tokyo (JP)

(21) Appl. No.: 14/263,943

(22) Filed: Apr. 28, 2014

Related U.S. Application Data
(60) Provisional application No. 61/928,884, filed on Jan. 17, 2014.

(51) Int. Cl. G06F 17/50; G06F 17/16

(52) U.S. Cl. CPC G06F 17/5009; G06F 17/16

(57) ABSTRACT

In one embodiment, a topography simulation apparatus includes a division module to divide a surface of a substance into a plurality of computing elements. The apparatus includes a first calculation module to calculate a surface movement rate in each computing element and to derive, for the plurality of computing elements, a first maximum which is a maximum of an absolute value of the surface movement rate. The apparatus includes a second calculation module to calculate a difference between surface movement rates in mutually adjacent computing elements and to derive, for the mutually adjacent computing elements among the plurality of computing elements, a second maximum which is a maximum of an absolute value of the difference between the surface movement rates. The apparatus includes a determination module to determine a time step for calculating a change in topography of the substance, based on the first or second maximum.

### CROSS REFERENCE TO RELATED APPLICATION

This application is based upon and claims the benefit of priority from the prior U.S. Provisional Patent Application No. 61/928,884 filed on Jan. 17, 2014, the entire contents of which are incorporated herein by reference.

### FIELD

Embodiments described herein relate to a topography simulation apparatus, a topography simulation method and a recording medium.

### BACKGROUND

When a surface of a substance is processed by chemical vapor deposition (CVD), reactive ion etching (RIE) or the like, a simulation of topography of the processed surface is an important technique. In this simulation, the surface of the substance is generally divided into computing elements (surface segments) to calculate a flux of a reactive species reaching each computing element and a local surface movement rate of the substance. However, when this simulation deals with a situation in which a film formation on the surface of the substance and a substance removal from the surface of the substance (for example, a deposition and an etching) occur simultaneously, there is a possibility that the calculation becomes inaccurate in the boundary region between a film formation region and a substance removal region.

### BRIEF DESCRIPTION OF THE DRAWINGS

FIG. 1 is a flowchart illustrating a procedure of a topography simulation method of a first embodiment;

FIG. 2 is a perspective view illustrating an example of an initial structure of a substance of the first embodiment;

FIG. 3 is a schematic diagram for illustrating a level set function;

FIG. 4 is a flowchart illustrating details of step S3 in FIG. 1;

FIG. 5 is a schematic diagram illustrating a substance surface divided into computing elements;

FIG. 6 is a schematic diagram for illustrating a surface movement rate “C” in each computing element;

FIG. 7 is a schematic diagram for illustrating a problem in a case of calculating a time step Δt;

FIG. 8 is a schematic diagram for illustrating the problem in the case of calculating the time step Δt;

FIG. 9 is a schematic diagram for illustrating a difference ΔC between surface movement rates “C” in mutually adjacent computing elements;

FIG. 10 is a flowchart illustrating a first example of a method of calculating the time step Δt in the first embodiment;

FIG. 11 is a flowchart illustrating a second example of the method of calculating the time step Δt in the first embodiment;

FIG. 12 is an outline view illustrating a configuration of a topography simulation apparatus of a second embodiment; and

FIG. 13 is a block diagram illustrating a configuration of a control module of FIG. 12.

### DETAILED DESCRIPTION

Embodiments will now be explained with reference to the accompanying drawings. In the drawings, identical or similar components are denoted by identical reference numerals, and a redundant description thereof is omitted as needed.

In one embodiment, a topography simulation apparatus includes a division module configured to divide a surface of a substance into a plurality of computing elements. The apparatus further includes a first calculation module configured to calculate a surface movement rate in each computing element and to derive, for the plurality of computing elements, a first maximum which is a maximum of an absolute value of the surface movement rate. The apparatus further includes a second calculation module configured to calculate a difference between surface movement rates in mutually adjacent computing elements and to derive, for the mutually adjacent computing elements among the plurality of computing elements, a second maximum which is a maximum of an absolute value of the difference between the surface movement rates. The apparatus further includes a determination module configured to determine a time step to be used for calculating a change in topography of the substance, based on the first or second maximum.

### First Embodiment

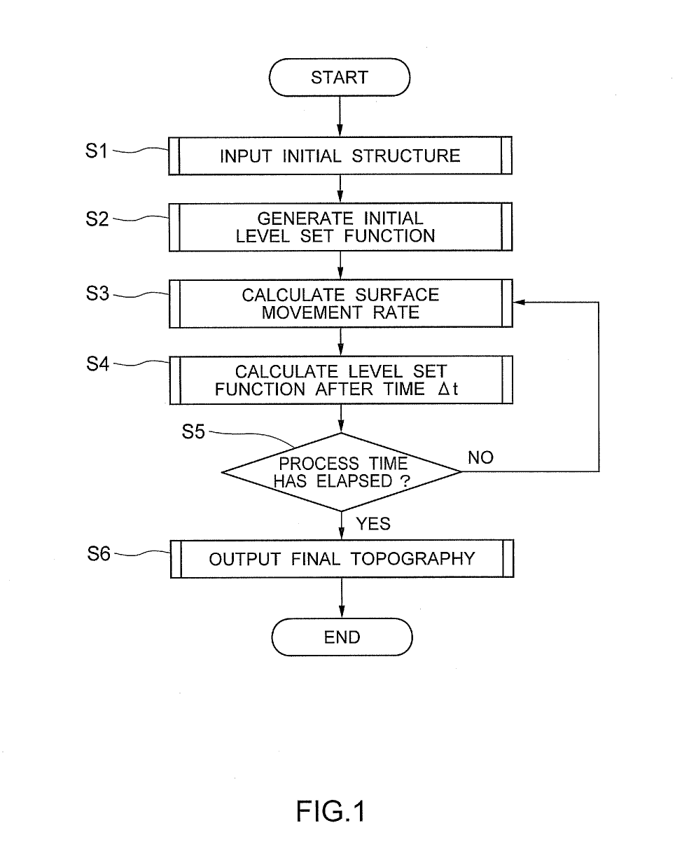

FIG. 1 is a flowchart illustrating a procedure of a topography simulation method of a first embodiment. The topography simulation method of this embodiment is carried out using an information processor such as a personal computer or a work station.

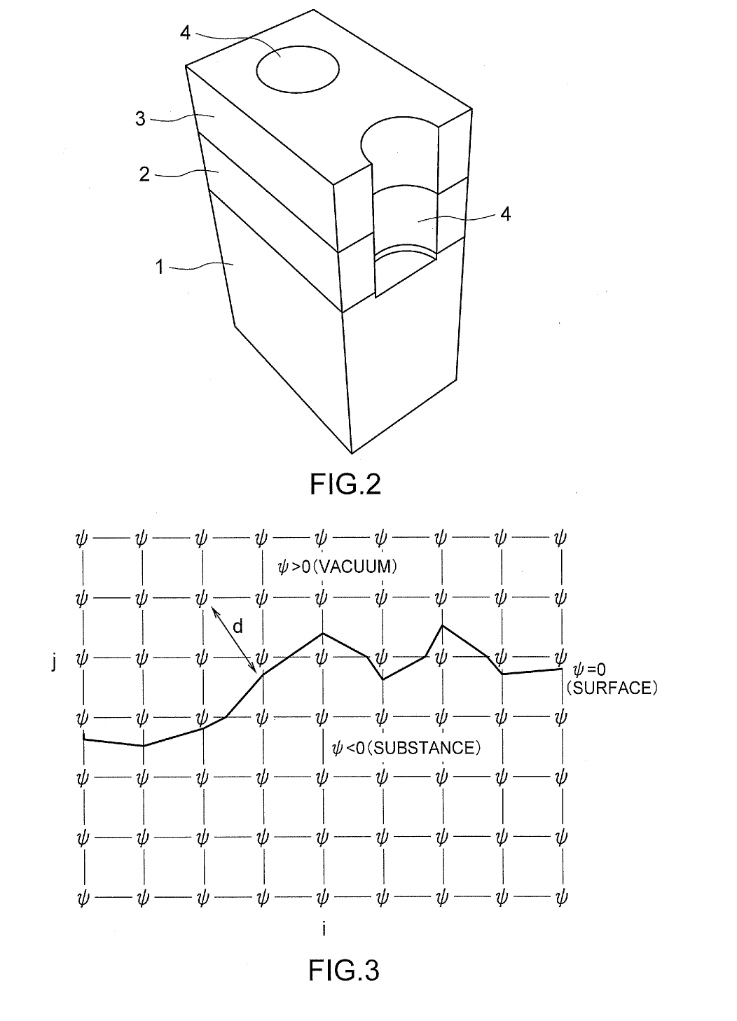

In the topography simulation method of this embodiment, an initial structure of a substance is inputted to an information processor (step S1). FIG. 2 is a perspective view illustrating an example of the initial structure of the substance of the first embodiment. The initial structure illustrated in FIG. 2 includes a silicon substrate 1, a silicon nitride film 2 and a silicon oxide film 3 formed in this order on the silicon substrate 1, and through holes 4 penetrating the silicon nitride film 2 and the silicon oxide film 3. Various formats may be used as examples of the method of inputting the initial structure. In this embodiment, however, a method is employed in which the topography of a substance surface is expressed by a sequence of points to be read by the information processing apparatus.

Next, an initial level set function is generated from the input initial structure (step S2). FIG. 3 is a schematic diagram for illustrating a level set function. A level set function φ is a function defined using a distance “d” from the surface of the substance, and has a value for each mesh within a calculating element. The value of the level set function φ is (φ=0) which is defined as 0 at the surface of the substance. Further, φ>0 holds at the outside (in vacuum) of the substance, and φ<0 holds at the inside of the substance (within the substance). In the case of generating the initial level set function, a surface closest to each mesh point is searched, and the distance “d” is calculated. Further, when a mesh point is in vacuum, a positive sign is set, and when the mesh point is within the substance, a negative sign is set. The initial level set function may be input in step S1, instead of being generated in step S2.

Next, a local surface movement rate “C” of the substance is calculated (step S3). The movement of the surface of the substance occurs, for example, by a film formation on the substance surface or a substance removal from the substance surface. Examples of the former case include deposition, oxidation, nitration and epitaxial growth. Examples of the latter case include etching and ashing.

Next, the level set function after a lapse of a time Δt is calculated using the surface movement rate “C” (step S4). The level set function φₜ at a time t can be calculated from the following formula (1).

$$\frac{\partial {φ}_{t}}{\partial t} + C \vert ∇ {φ}_{t} \vert = 0 \qquad ( 1 )$$

where ∇ represents a vector differential operator, |∇φₜ| represents a norm of ∇φₜ. The level set function after a lapse of the time Δt allows calculation by performing time evolution on the level set function in accordance with a formula obtained by discretizing the formula (1). The time Δt represents a time step for performing the time evolution calculation for the level set function. A block that performs the process of step S4 is an example of a third calculation module in the disclosure.

Next, it is determined whether a preset process time has elapsed or not (step S5). When the process time is ended, the final topography of the substance is output (step S6), and the calculation ends. When the process time is not ended, the process returns to step S3.

In this embodiment, a level set method is employed as a technique for expressing the topography, but techniques, such as a string method, other than the level set method may be employed.

(1) Details of Step S3

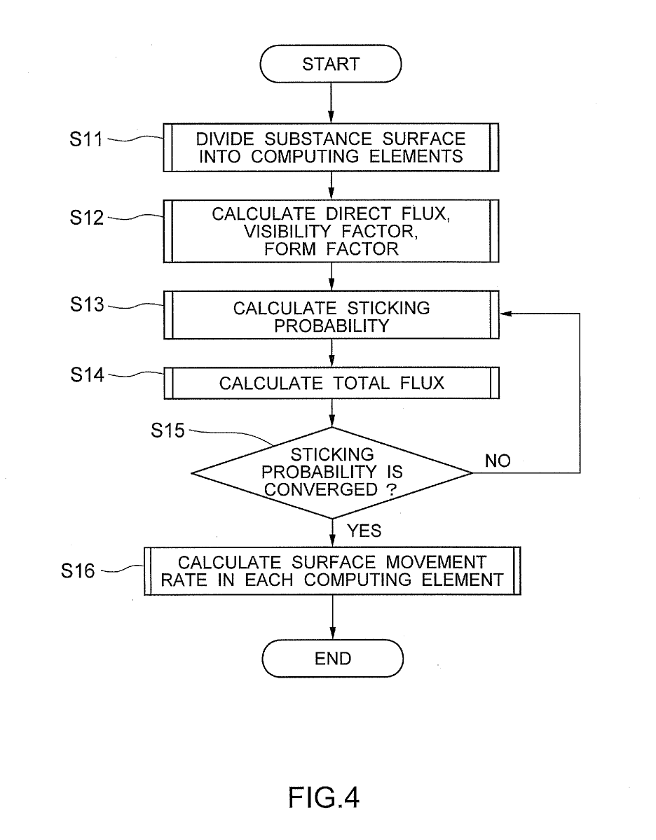

Referring next to FIG. 4, step S3 will be described in detail.

FIG. 4 is a flowchart illustrating details of step S3 in FIG. 1.

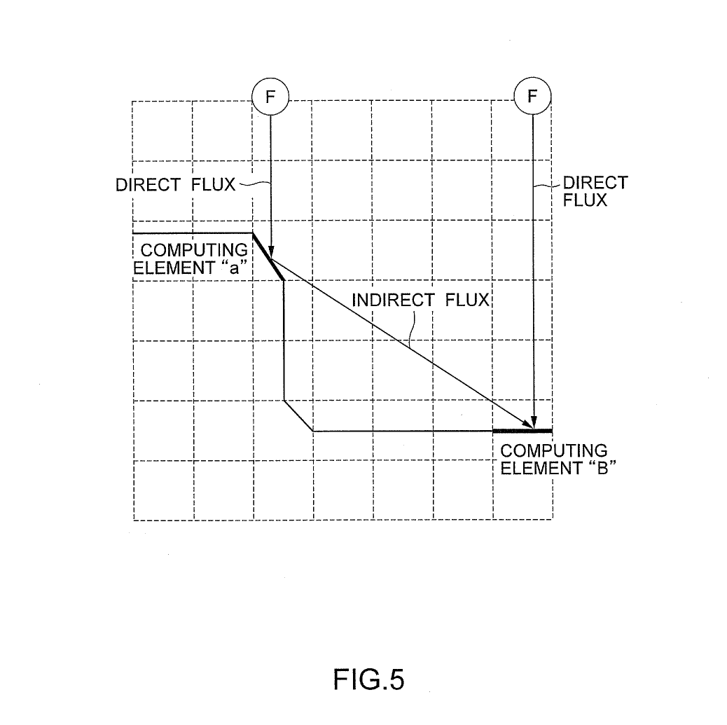

First, the substance surface represented by the level set method is divided into a plurality of computing elements (step S11). FIG. 5 is a schematic diagram illustrating the substance surface divided into the computing elements. In the example of FIG. 5, the substance surface is divided for each mesh. As a result, the substance surface within one mesh is one computing element. A block that performs the process of step S11 is an example of a division module described herein.

The method of dividing the substance surface is not limited to the unit of mesh, but any method may be employed. The division of the substance surface is not necessarily performed for each time step Δt, but may be performed immediately after step S1, for example.

Though the calculation element illustrated in FIG. 5 is a two-dimensional area, a three-dimensional area may be used instead. The shape of each computer element illustrated in FIG. 5 is a line segment, but a point, a polygon or the like may be used instead.

FIG. 5 illustrates a first computing element “a” and a second computing element “B”. In the case of calculating the flux of the reactive species reaching the computing element “B”, the flux of the reactive species directly reaching the computing element “B” from a gas space, and the flux of the reactive species indirectly reaching the computing element “B” through any computing element “a” are generally taken into consideration. The former flux is referred to as a direct flux, and is represented by Γ_{B,direct}. The latter flux is referred to as an indirect flux, and is represented by Γ_{aB,indirect}. The sum of these fluxes is referred to as a total flux. Examples of the reactive species include a deposition species and an etching species.

The indirect flux Γ_{aB,indirect}, which reaches the computing element “B” through any computing element “a”, can be represented by the following formula (2), for example.

Γ_{aB,indirect}=(1−Sₐ(Γₐ))ν(a,B)g(a,B)Γₐ (2)

where Sₐ(Γₐ) represents a sticking probability indicating a ratio of the flux adsorbed on each computing element “a” to the flux reaching each computing element “a”. The value of Sₐ(Γₐ) depends on the total flux Γₐ in each computing element “a”. Further, ν(a, B) represents a visibility factor (face-to-face visibility factor) indicating whether the computing element “a” and the computing element “B” are visible to each other. When the straight line connecting the computing elements “a” and “B” contacts the substance surface, ν=0 holds. When the straight line does not contact the substance surface, ν=1 holds. Further, g(a, B) represents a form factor illustrating a positional relationship (face relation) between the computing element “a” and the computing element “B”. The value of g(a, B) represents a degree at which the computing elements “a” and “B” are visible to each other. The value of g(a, B) depends on the distance and angle between the computing elements “a” and “B”.

In the flow of FIG. 4, the direct flux in any computing element, and the visibility factor ν and the form factor “g” between arbitrary computing elements are then calculated (step S12).

Next, a direct flux Γ_{j,direct} of each computing element “j” is used as a temporal total flux Γⱼ, and a sticking probability Sⱼ(Γⱼ) in each computing element “j” is calculated (step S13). In this case, this flux may include neutral molecules, ions having directivity, or the both thereof.

Next, the total flux Γᵢ for each computing element “i” in a system made of “M” computing elements is calculated from the following formula (3), by using the visibility factor ν, the form factor “g”, the temporal total flux Γⱼ, and the sticking probability Sⱼ(Γⱼ) (step S14).

$${Γ}_{i , direct} = {Γ}_{i} - {\sum }_{j = 1}^{M} ( 1 - {S}_{j} ( {Γ}_{j} ) ) v ( i , j ) g ( i , j ) {Γ}_{j} \qquad ( 3 )$$

Next, the processes of steps S13 and S14 are repeated until the value of the sticking probability Sⱼ(Γⱼ) is converged (step S15). In the second and subsequent step S13, the total flux Γⱼ, which is calculated in the previous step S14, is used as the temporal total flux Γⱼ. In step S15, it is determined whether the value of Sⱼ(Γⱼ) is converged or not based on whether a change in Sⱼ(Γⱼ) is equal to or smaller than a threshold. The total flux Γᵢ obtained when the value of Sⱼ(Γⱼ) is converged is treated as a correct calculation result of the total flux Γᵢ.

In the case of the system made of “M” computing elements, the visibility factor ν and the form factor “g” between arbitrary computing elements can be collectively expressed as an M×M matrix. The visibility factor ν and the form factor “g”, which are represented by a matrix form, are respectively referred to as a visibility factor matrix and a form factor matrix. The flux in any computing element can be represented by an M-row vector. The flux represented by a vector form is referred to as a flux vector.

In this case, the formula (3) can be expressed by a matrix equation as in the following formula (4).

$$\begin{matrix}A {\vec{Γ}}_{i} = {\vec{Γ}}_{i , direct} & ( 4 ) \\ {\vec{Γ}}_{i} = [ \begin{matrix}{Γ}_{1} \\ {Γ}_{2} \\ ⋮ \\ {Γ}_{i} \\ ⋮ \\ {Γ}_{M}\end{matrix} ] & ( 5 ) \\ {\vec{Γ}}_{i , direct} = [ \begin{matrix}{Γ}_{1 , direct} \\ {Γ}_{2 , direct} \\ ⋮ \\ {Γ}_{i , direct} \\ ⋮ \\ {Γ}_{M , direct}\end{matrix} ] & ( 6 ) \\ A = [ \begin{matrix}1 + ( {S}_{1} ( {Γ}_{1} ) - 1 ) v ( 1 , 1 ) g ( 1 , 1 ) & ( {S}_{2} ( {Γ}_{2} ) - 1 ) v ( 1 , 2 ) g ( 1 , 2 ) & ⋯ & ( {S}_{j} ( {Γ}_{j} ) - 1 ) v ( 1 , j ) g ( 1 , j ) & ⋯ & {S}_{M} ( {Γ}_{M} ) - 1 ) v ( 1 , M ) g ( 1 , M ) \\ ( {S}_{i} ( {Γ}_{i} ) - 1 ) v ( 2 , 1 ) g ( 2 , 1 ) & 1 + ( {S}_{2} ( {Γ}_{2} ) - 1 ) v ( 2 , 2 ) g ( 2 , 2 ) & ⋯ & ( {S}_{j} ( {Γ}_{j} ) - 1 ) v ( 2 , j ) g ( 2 , j ) & ⋯ & {S}_{M} ( {Γ}_{M} ) - 1 ) v ( 2 , M ) g ( 2 , M ) \\ ⋮ & ⋮ & ⋱ & ⋮ & ⋯ & ⋮ \\ ( {S}_{1} ( {Γ}_{1} ) - 1 ) v ( i , 1 ) g ( i , 1 ) & ( {S}_{2} ( {Γ}_{2} ) - 1 ) v ( i , 2 ) g ( i , 2 ) & ⋯ & 1 + ( {S}_{j} ( {Γ}_{J} ) - 1 ) v ( i , j ) g ( i , j ) & ⋯ & ( {S}_{M} ( {Γ}_{M} ) - 1 ) v ( i , M ) g ( i , M ) \\ ⋮ & ⋮ & ⋮ & ⋮ & ⋱ & ⋮ \\ ( {S}_{1} ( {Γ}_{1} ) - 1 ) v ( M , 1 ) g ( M , 1 ) & ( {S}_{2} ( {Γ}_{2} ) - 1 ) v ( M , 2 ) g ( M , 2 ) & ⋯ & ( {S}_{j} ( {Γ}_{j} ) - 1 ) v ( M , j ) g ( M , j ) & ⋯ & 1 + ( {S}_{M} ( {Γ}_{M} ) - 1 ) v ( M , M ) g ( M , M )\end{matrix} ] & ( 7 )\end{matrix}$$

The matrix equation (4) can be solved by any solving method. Examples of the solution include an iterative method (Gauss-Seidel method, SOR method, Jacobi method, conjugate gradient method, etc.), and a direct method (Gaussian elimination, LU decomposition method, Choleski decomposition method, etc.). In the case of solving the matrix equation (4), when the matrix “A” is a sparse matrix, memory saving and speed-up of the calculation process may be achieved by using a routine suitable for the sparse matrix using a storage method such as CRS.

In the flow of FIG. 4, a local surface movement rate Cᵢ in each computing element “i” is then calculated from the total flux Γᵢ (step S16). For example, in the case of using “K” types of reactive species, the surface movement rate Cᵢ is modeled in the form of the following formula (8) depending on “K” local total fluxes Γ_{1,i} to Γ_{K,i}.

Cᵢ=ƒ(Γ_{1,j}, . . . ,Γ_{k,i} . . . ,Γ_{K,i}) (8)

where “k” is any natural number that satisfies 1≦k≦K. As described above, the process of step S3 is ended.

(2) Method of Calculating Time Step Δt

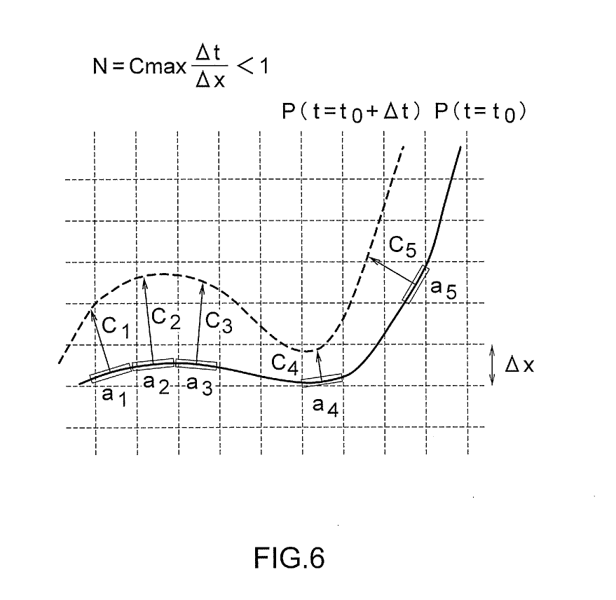

Next, referring to FIGS. 6 to 11, the method of calculating the time step Δt to be used in step S4 will be described.

FIG. 6 is a schematic diagram for illustrating the surface movement rate “C” in each computing element.

FIG. 6 illustrates a substance surface P(t=t₀) at the time t=t₀, and a substance surface P(t=t₀+Δt) at the time t=t₀+Δt. The surface P(t=t₀) consists of points at which the values of the level set function φ(t=t₀) are 0. The surface P(t=t₀+Δt) consists of points at which the values of the level set function φ(t=t₀+Δt) are 0. The sign Δx represents the length of one side of the mesh by which the surface of the substance is divided. The length Δx corresponds to the grid interval.

FIG. 6 further illustrates computing elements a₁ to a₅ constituting the surface P(t=t₀), and the surface movement rates C₁ to C₅ in the computing elements a₁ to a₅. The surface movement rates C₁ to C₅ in this embodiment are vector quantities. Hereinafter, any computing element is represented by the sign “a”, and the surface movement rate in any computing element “a” is represented by the sign “C”.

The time step Δt in this embodiment is set so as to satisfy the CFL (Courant Friedriches Lewy) condition. The CFL condition is a necessary condition that the propagation speed of information in a numerical calculation should be greater than the propagation speed of waves or physical quantities in an actual phenomenon. The CFL condition in this embodiment is represented by the following formula (9).

$$N = {C}_{max} \frac{Δ t}{Δ x} < 1 \qquad ( 9 )$$

The sign Cₘₐₓ represents the maximum of the absolute values |C| of the surface movement rates “C” in all the computing elements “a” that are present at the time t=t₀ (Cₘₐₓ=max[|C|]). For example, in the case where the absolute value |C₁| of the surface movement rate C₁ in the computing element a₁ is the maximum among the absolute values |C| of the surface movement rates “C” in all the computing elements “a” that are present at the time t=t₀, the maximum Cₘₐₓ at the time t=t₀ is |C₁|. Hereinafter, the maximum Cₘₐₓ is referred to as a first maximum, for distinguishing it from a maximum ΔCₘₐₓ described later.

The sign “N” represents a Courant number in the CFL condition. The Courant number is a constant that is more than 0 and less than 1 (0<N<1). The time step Δt in this embodiment can be calculated, for example, by setting the Courant number “N”, deriving the first maximum Cₘₐₓ, and then calculating Δt=NΔx/Cₘₐₓ. Details of the method of calculating the time step Δt in this embodiment will be described later.

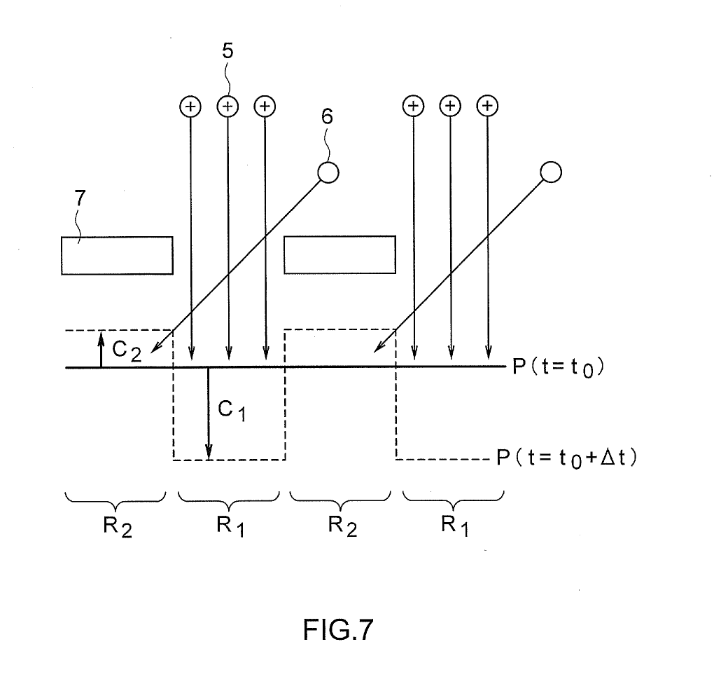

FIG. 7 is a schematic diagram for illustrating a problem in a case of calculating the time step Δt.

FIG. 7 illustrates a situation in which a film formation on the surface of the substance and a substance removal from the surface of the substance occur simultaneously. FIG. 7 illustrates etching particles 5 for etching the surface of the substance, depositing particles 6 for depositing a film on the surface of the substance, and a photomask 7 covering the surface of the substance.

The substance surface P(t=t₀) at the time t=t₀ is classified into an etching region R₁ and a deposition region R₂. The etching region R₁ is not covered with the photomask 7, so that its surface is etched by the etching particles 5. The deposition region R₂ is covered the photomask 7, so that the film is deposited on its surface by the depositing particles 6.

The sign C₁ in FIG. 7 represents the surface movement rate in the etching region R₁. The sign C₂ in FIG. 7 represents the surface movement rate in the deposition region R₂. Generally, the surface movement rate C₁ in the etching region R₁ is toward the inward direction of the substance, while the surface movement rate C₂ in the deposition region R₂ is toward the outward direction of the substance. Accordingly, there is a possibility that the calculation of the change in the substance topography becomes inaccurate in the boundary region between the etching region R₁ and the deposition region R₂. In the following, the reason of this will be described in detail.

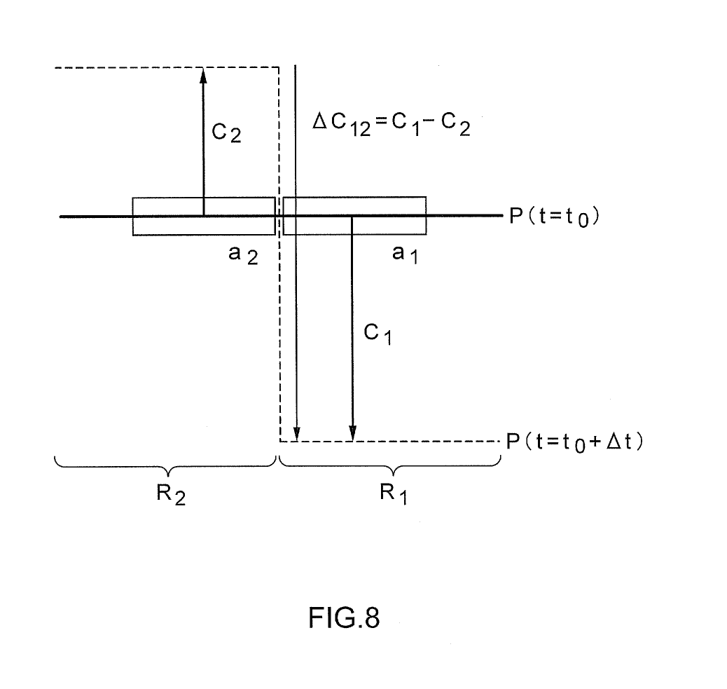

FIG. 8 is a schematic diagram for illustrating the problem in the case of calculating the time step Δt.

FIG. 8 illustrates the computing element a₁ in the etching region R₁, the surface movement rate C₁ in the computing element a₁, the computing element a₂ in the deposition region R₂, and the surface movement rate C₂ in the computing element a₂. The computing element a₁ and the computing element a₂ are mutually adjacent. FIG. 8 further illustrates the difference ΔC₁₂ between the surface movement rate C₁ and the surface movement rate C₂ (ΔC₁₂=C₁−C₂). The surface movement rates C₁, C₂ and their difference ΔC₁₂ in this embodiment are all vector quantities.

The time step Δt in this embodiment is set so as to satisfy the above formula (9). Accordingly, the surface movement rates C₁, C₂ satisfy the following formulas (10), (11), respectively. This is because the absolute values |C₁|, |C₂| of the surface movement rates C₁, C₂ are equal to or less than the first maximum Cₘₐₓ.

$$\begin{matrix}\vert {C}_{1} \vert \frac{Δ t}{Δ x} < 1 & ( 10 ) \\ \vert {C}_{2} \vert \frac{Δ t}{Δ x} < 1 & ( 11 )\end{matrix}$$

However, the difference ΔC₁₂ does not always satisfy the following formula (12). This is because the absolute value |ΔC₁₂| of the difference ΔC₁₂ can be more than the first maximum Cₘₐₓ in the boundary region between the etching region R₁ and the deposition region R₂.

$$\vert Δ {C}_{12} \vert \frac{Δ t}{Δ x} < 1 \qquad ( 12 )$$

The difference ΔC₁₂ not satisfying the formula (12) means that the surface in the computing element a₁ and the surface in the computing elements a₂ get away from each other at a speed exceeding the propagation speed of information. As a result, there is a possibility that the calculation of the change in the substance topography becomes inaccurate in the boundary region between the computing elements a₁, a₂. Specifically, there is a possibility that the substance topography becomes unstable in the boundary region between the computing elements a₁, a₂.

In this embodiment, the CFL condition is therefore applied to not only the surface movement rate “C” but also the difference ΔC between the surface movement rates “C”. Specifically, the CFL condition of the above formula (9) and the CFL condition of the following formula (13) are selectively applied in this embodiment.

$$N = Δ {C}_{max} \frac{Δ t}{Δ x} < 1 \qquad ( 13 )$$

The sign ΔCₘₐₓ represents the maximum of the absolute value |ΔC| of the difference ΔC between the surface movement rates “C”, in the case of considering all combinations of mutually adjacent computing elements “a” among all the computing elements “a” that are present at the time t=t₀ (ΔCₘₐₓ=max[|ΔC|]). For example, in the case where the absolute value |ΔC₁₂| of the difference ΔC₁₂ between the surface movement rates C₁, C₂ in the computing elements a₁, a₂ is the maximum among all combinations of mutually adjacent computing elements “a”, the maximum ΔCₘₐₓ at the time t=t₀ is |ΔC₁₂|. Hereinafter, the maximum ΔCₘₐₓ is referred to as a second maximum, for distinguishing it from the maximum Cₘₐₓ described previously.

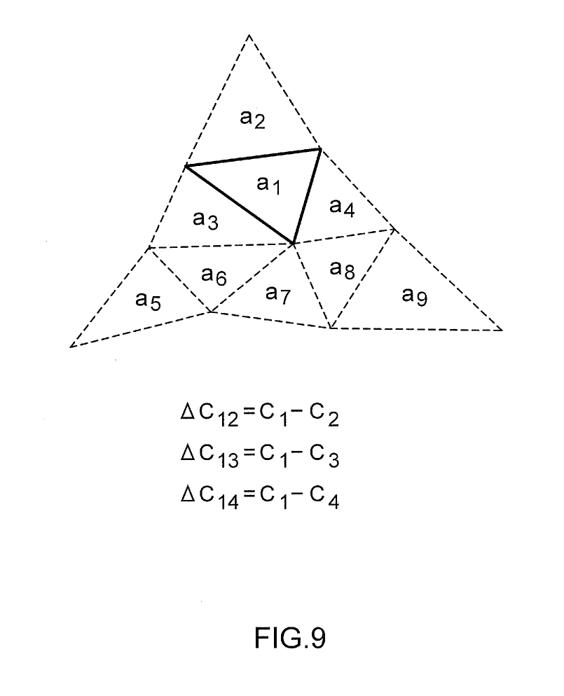

FIG. 9 is a schematic diagram for illustrating the difference ΔC between the surface movement rates “C” in mutually adjacent computing elements.

FIG. 9 illustrates nine computing elements a₁ to a₉. The computing elements adjacent to the computing element a₁ in FIG. 9 are three computing elements a₂, a₃, a₄. Therefore, in the case of calculating the difference ΔC between the surface movement rates “C” with respect to the computing element a₁, differences ΔC₁₂ (=C₁−C₂), ΔC₁₃ (=C₁−C₃), ΔC₁₄ (=C₁−C₄) are calculated. The signs C₁ to C₄ represent the surface movement rates in the computing elements a₁ to a₄, respectively.

### First Example

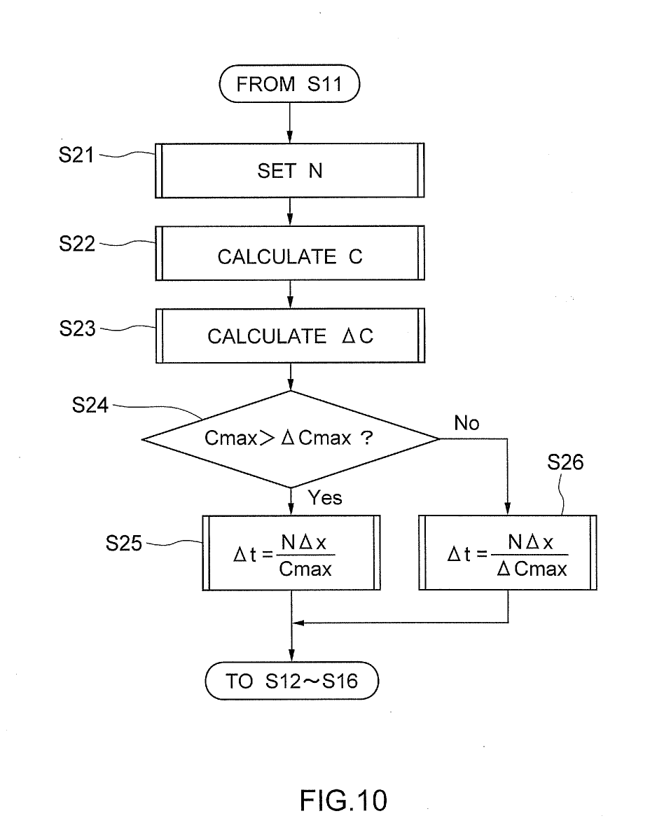

FIG. 10 is a flowchart illustrating a first example of the method of calculating the time step Δt in the first embodiment.

After the execution of the process of step S11, the Courant number “N” is set (step S21). The Courant number “N” is set to a value that is more than 0 and less than 1 (0<N<1).

For all the computing elements “a” that are present at the time t=t₀, the surface movement rate “C” is then calculated (step S22). For these computing elements “a”, the first maximum Cₘₐₓ of the absolute value |C| of the surface movement rate “C” is derived (step S22). A block that performs the process of step S22 is an example of a first calculation module in the disclosure.

For all combinations of the mutually adjacent computing elements “a” at the time t=t₀, the difference ΔC between the surface movement rates “C” is then calculated (step S23). For these combinations, the second maximum ΔCₘₐₓ of the absolute value |ΔC| of the difference ΔC between the surface movement rates “C” is derived (step S23). A block that performs the process of step S23 is an example of a second calculation module in the disclosure.

The first maximum Cₘₐₓ and the second maximum ΔCₘₐₓ then compared (step S24).

As a result, if the first maximum Cₘₐₓ is more than the second maximum ΔCₘₐₓ the time step Δt at the time t=t₀ is determined based on the first maximum Cₘₐₓ and the Courant number “N” (step S25). Specifically, the time step Δt is given by Δt=NΔx/Cₘₐₓ.

On the other hand, if the first maximum Cₘₐₓ is less than the second maximum ΔCₘₐₓ, the time step Δt at the time t=t₀ is determined based on the second maximum ΔCₘₐₓ and the Courant number “N” (step S26). Specifically, the time step Δt is given by Δt=NΔx/ΔCₘₐₓ.

In this way, the time step Δt in this embodiment is determined based on the first or second maximum Cₘₐₓ, ΔCₘₐₓ and the common Courant number “N” between the first and second maxima Cₘₐₓ, ΔCₘₐₓ. A block that performs the processes of steps S24 to S26 is an example of a determination module in the disclosure. If the first maximum Cₘₐₓ is equal to the second maximum ΔCₘₐₓ, either process of steps S25 and S26 may be performed.

Thereafter, the processes of steps S12 to S16 are executed in this embodiment. The time step determined by the process of FIG. 10 is used in the process of step S4.

As described above, the time step Δt in the first example is determined based on the larger one of the first and second maxima Cₘₐₓ, ΔCₘₐₓ. Therefore, according to the first example, the following formulas (14) and (15) are both satisfied whichever of the first and second maxima Cₘₐₓ, ΔCₘₐₓ is larger.

$$\begin{matrix}{C}_{max} \frac{Δ t}{Δ x} < 1 & ( 14 ) \\ Δ {C}_{max} \frac{Δ t}{Δ x} < 1 & ( 15 )\end{matrix}$$

Therefore, it is possible in the first example to prevent the calculation of the change in the substance topography from becoming inaccurate in the boundary region between the etching region R₁ and the deposition region R₂.

### Second Example

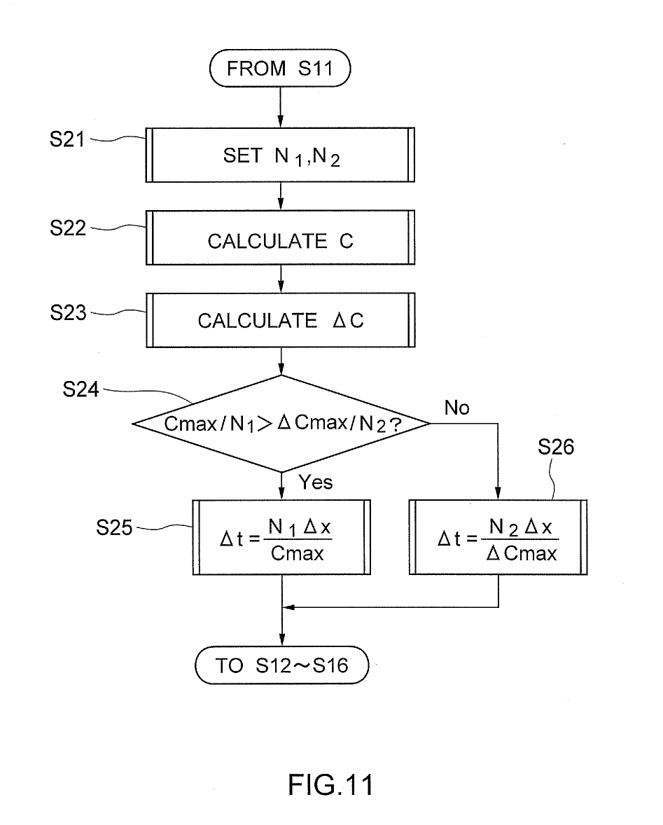

FIG. 11 is a flowchart illustrating a second example of the method of calculating the time step Δt in the first embodiment.

After the execution of the process of step S11, a first Courant number N₁ to be used for the first maximum Cₘₐₓ, and a second Courant number N₂ to be used for the second maximum ΔCₘₐₓ are set (step S21). The first and second Courant numbers N₁, N₂ are set to values that are more than 0 and less than 1 (0<N₁<1, 0<N₂<1).

For all the computing elements “a” that are present at the time t=t₀, the surface movement rate “C” is then calculated (step S22). For these computing elements “a”, the first maximum Cₘₐₓ of the absolute value |C| of the surface movement rate “C” is derived (step S22). A block that performs the process of step S22 is an example of the first calculation module in the disclosure.

For all combinations of the mutually adjacent computing elements “a” at the time t=t₀, the difference ΔC between the surface movement rates “C” is then calculated (step S23). For these combinations, the second maximum ΔCₘₐₓ of the absolute value |ΔC| of the difference ΔC between the surface movement rates “C” is derived (step S23). A block that performs the process of step S23 is an example of the second calculation module in the disclosure.

The value Cₘₐₓ/N₁ obtained by dividing the first maximum Cₘₐₓ by the first Courant number N₁, and the value ΔCₘₐₓ/N₂ obtained by dividing the second maximum ΔCₘₐₓ by the second Courant number N₂ are then compared (step S24).

As a result, if the value Cₘₐₓ/N₁ is more than the value ΔCₘₐₓ/N₂, the time step Δt at the time t=t₀ is determined based on the first maximum Cₘₐₓ and the first Courant number N₁ (step S25). Specifically, the time step Δt is given by Δt=N₁Δx/Cₘₐₓ.

On the other hand, if the value Cₘₐₓ/N₁ is less than the value ΔCₘₐₓ/N₂, the time step Δt at the time t=t₀ is determined based on the second maximum ΔCₘₐₓ and the second Courant number N₂ (step S26). Specifically, the time step Δt is given by Δt=N₂Δx/ΔCₘₐₓ.

In this way, the time step Δt in this embodiment is determined based on the first maximum Cₘₐₓ and the first Courant number N₁, or based on the second maximum ΔCₘₐₓ and the second Courant number N₂. A block that performs the processes of steps S24 to S26 is an example of the determination module in the disclosure. If the value Cₘₐₓ/N₁ is equal to the value ΔCₘₐₓ/N₂, either process of steps S25 and S26 may be performed.

Thereafter, the processes of steps S12 to S16 are executed in this embodiment. The time step determined by the process of FIG. 11 is used in the process of step S4.

As described above, the time step Δt in the second example is determined based on the larger one of the value Cₘₐₓ/N₁ and the value ΔCₘₐₓ/N₂. Accordingly, the smaller one of Δt=N₁Δx/Cₘₐₓ and Δt=N₂Δx/ΔCₘₐₓ is adopted as the value of the time step Δt in the second example. Therefore, according to the second example, the above formulas (14) and (15) are both satisfied whichever of the value Cₘₐₓ/N₁ and the value ΔCₘₐₓ/N₂ is larger.

Therefore, it is possible in the second example to prevent the calculation of the change in the substance topography from becoming inaccurate in the boundary region between the etching region R₁ and the deposition region R₂, as similar to the first example.

Furthermore, the second example can make the Courant number for the surface movement rate “C” be different from the Courant number for the difference ΔC, and therefore can apply the CFL condition with a high degree of freedom. On the other hand, the first example can make the Courant number for the surface movement rate “C” be identical with the Courant number for the difference ΔC, and therefore can simplify the application of the CFL condition.

As described above, the time step Δt for calculating the change in the substance topography in this embodiment is determined based on the first maximum Cₘₐₓ of the absolute value |C| of the surface movement rate “C” or the second maximum ΔCₘₐₓ of the absolute value |ΔC| of the difference ΔC between the surface movement rates “C”.

Therefore, according to this embodiment, in the case of dealing with the situation in which the film formation on the surface of the substance and the substance removal from the surface of the substance occur simultaneously, it is possible to prevent the calculation from becoming inaccurate in the boundary region between the film formation region and the substance removal region.

This embodiment can be applied to the case where the film is formed on the surface of the substance by a factor other than deposition, and the case where the substance is removed from the surface of the substance by a factor other than etching.

### Second Embodiment

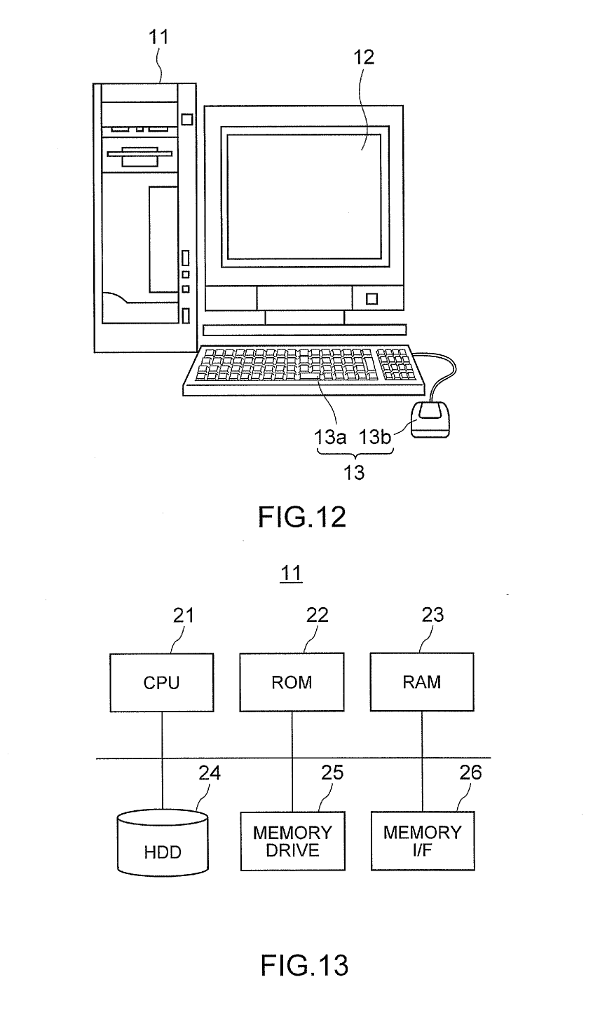

FIG. 12 is an outline view illustrating a configuration of a topography simulation apparatus of a second embodiment.

The topography simulation apparatus illustrated in FIG. 12 includes a control module 11, a display module 12, and an input module 13.

The control module 11 controls the operation of the topography simulation apparatus. The control module 11 executes the topography simulation method of the first embodiment, for example. The control module 11 will be described in detail later.

The display module 12 includes a display device such as a liquid crystal monitor. The display module 12 displays a configuration information input screen for the topography simulation, and a calculation result of the topography simulation, for example.

The input module 13 includes input devices such as a keyboard 13a and a mouse 13b. The input module 13 is used for inputting configuration information for the topography simulation, for example. Examples of the configuration information include information on a calculation formula, information on an experimental value or a predicted value, information on the structure of the substance, information on a flux, and instruction information on the configurations and procedures for the topography simulation.

FIG. 13 is a block diagram illustrating a configuration of the control module 11 of FIG. 12.

The control module 11 includes a CPU (central processing unit) 21, a ROM (read only memory) 22, a RAM (random access memory) 23, an HDD (hard disk drive) 24, a memory drive 25 such as a CD (compact disc) drive, and a memory I/F (interface) 26 such as a memory port or a memory slot.

In this embodiment, a topography simulation program, which is a program for the topography simulation method of the first embodiment, is stored in the ROM 22 or the HDD 24. Upon receiving predetermined instruction information from the input module 13, the CPU 21 reads out the program from the ROM 22 or the HDD 24, develops the read program in the RAM 23, and executes the topography simulation by this program. Various data generated during this process are held in the RAM 23.

In this embodiment, a computer readable recording medium non-transitorily stores the topography simulation program, and the topography simulation program may be installed from the recording medium into the ROM 22 or the HDD 24. Examples of the recording medium include a CD-ROM and a DVD-ROM (digital versatile disk ROM).

Further, in this embodiment, the topography simulation program can be downloaded via a network such as the Internet to be installed in the ROM 22 or the HDD 24.

As described above, according to this embodiment, it is possible to provide a topography simulation apparatus and a topography simulation program for executing the topography simulation method of the first embodiment.

In the first and second embodiments, a semiconductor device is adopted as an example of the object to which the topography simulation is applied, but the topography simulation can also be applied to devices other than the semiconductor device. Examples of such devices include a micro electro mechanical systems (MEMS) device and a display device.

While certain embodiments have been described, these embodiments have been presented by way of example only, and are not intended to limit the scope of the inventions. Indeed, the novel apparatuses, methods and media described herein may be embodied in a variety of other forms; furthermore, various omissions, substitutions and changes in the form of the apparatuses, methods and media described herein may be made without departing from the spirit of the inventions. The accompanying claims and their equivalents are intended to cover such forms or modifications as would fall within the scope and spirit of the inventions.

1. A topography simulation apparatus comprising:
a division module configured to divide a surface of a substance into a plurality of computing elements;
a first calculation module configured to calculate a surface movement rate in each computing element and to derive, for the plurality of computing elements, a first maximum which is a maximum of an absolute value of the surface movement rate,
a second calculation module configured to calculate a difference between surface movement rates in mutually adjacent computing elements and to derive, for the mutually adjacent computing elements among the plurality of computing elements, a second maximum which is a maximum of an absolute value of the difference between the surface movement rates; and
a determination module configured to determine a time step to be used for calculating a change in topography of the substance, based on the first or second maximum.

2. The apparatus of claim 1, wherein the determination module determines the time step based on the first or second maximum and a common Courant number between the first and second maxima.

3. The apparatus of claim 2, wherein
the determination module determines the time step based on the first maximum and the common Courant number, when the first maximum is more than the second maximum, and
the determination module determines the time step based on the second maximum and the common Courant number, when the first maximum is less than the second maximum.

4. The apparatus of claim 1, wherein the determination module determines the time step based on the first maximum and a first Courant number to be used for the first maximum, or based on the second maximum and a second Courant number to be used for the second maximum.

5. The apparatus of claim 4, wherein
the determination module determines the time step based on the first maximum and the first Courant number, when a value of the first maximum divided by the first Courant number is more than a value of the second maximum divided by the second Courant number, and
the determination module determines the time step based on the second maximum and the second Courant number, when the value of the first maximum divided by the first Courant number is less than the value of the second maximum divided by the second Courant number.

6. The apparatus of claim 4, wherein the first and second Courant numbers are more than 0 and less than 1.

7. The apparatus of claim 1, wherein the calculation of the change in topography of the substance is performed for a case where a formation of a film on the surface of the substance and a removal of the substance from the surface of the substance occur simultaneously.

8. The apparatus of claim 1, further comprising a third calculation module configured to calculate the change in topography of the substance by performing a time evolution on a level set function along with the time step, the level set function being defined using a distance from the surface of the substance.

9. A topography simulation method comprising:
dividing a surface of a substance into a plurality of computing elements;
calculating a surface movement rate in each computing element and to derive, for the plurality of computing elements, a first maximum which is a maximum of an absolute value of the surface movement rate;
calculating a difference between surface movement rates in mutually adjacent computing elements and to derive, for the mutually adjacent computing elements among the plurality of computing elements, a second maximum which is a maximum of an absolute value of the difference between the surface movement rates; and
determining a time step to be used for calculating a change in topography of the substance, based on the first or second maximum.

10. The method of claim 9, wherein the time step is determined based on the first or second maximum and a common Courant number between the first and second maxima.

11. The method of claim 10, wherein
the time step is determined based on the first maximum and the common Courant number, when the first maximum is more than the second maximum, and
the time step is determined based on the second maximum and the common Courant number, when the first maximum is less than the second maximum.

12. The method of claim 9, wherein the time step is determined based on the first maximum and a first Courant number to be used for the first maximum, or based on the second maximum and a second Courant number to be used for the second maximum.

13. The method of claim 12, wherein
the time step is determined based on the first maximum and the first Courant number, when a value of the first maximum divided by the first Courant number is more than a value of the second maximum divided by the second Courant number, and
the time step is determined based on the second maximum and the second Courant number, when the value of the first maximum divided by the first Courant number is less than the value of the second maximum divided by the second Courant number.

14. The method of claim 12, wherein the first and second Courant numbers are more than 0 and less than 1.

15. The method of claim 9, wherein the calculation of the change in topography of the substance is performed for a case where a formation of a film on the surface of the substance and a removal of the substance from the surface of the substance occur simultaneously.

16. The method of claim 9, further comprising calculating the change in topography of the substance by performing a time evolution on a level set function along with the time step, the level set function being defined using a distance from the surface of the substance.

17. A non-transitory computer-readable recording medium containing a topography simulation program which causes a computer to perform a topography simulation method, the method comprising:
dividing a surface of a substance into a plurality of computing elements;
calculating a surface movement rate in each computing element and to derive, for the plurality of computing elements, a first maximum which is a maximum of an absolute value of the surface movement rate;
calculating a difference between surface movement rates in mutually adjacent computing elements and to derive, for the mutually adjacent computing elements among the plurality of computing elements, a second maximum which is a maximum of an absolute value of the difference between the surface movement rates; and
determining a time step to be used for calculating a change in topography of the substance, based on the first or second maximum.

18. The medium of claim 17, wherein the time step is determined based on the first or second maximum and a common Courant number between the first and second maxima.

19. The medium of claim 17, wherein the time step is determined based on the first maximum and a first Courant number to be used for the first maximum, or based on the second maximum and a second Courant number to be used for the second maximum.

20. The medium of claim 17, wherein the calculation of the change in topography of the substance is performed for a case where a formation of a film on the surface of the substance and a removal of the substance from the surface of the substance occur simultaneously.
